(19) United States
(12) Patent Application Publication
(10) Pub. No.: US 2005/0133478 A1
(43) Pub. Date: Jun. 23, 2005

(54) Microlens fabrication method

(76) Inventors: Jong Sam Kim, Suwon (KR); Jin Ha Kim, Sungnam (KR); Sung Jun Lee, Seoul (KR); Ro Woon Lee, Seoul (KR); Yoon Shik Hong, Sungnam (KR)

Correspondence Address: LOWE HAUPTMAN GILMAN & BERNER, LLP, Suite 310, 1700 Diagonal Road, Alexandria, VA, 22314, US

(21) Appl. No.: 10/822,693

(22) Filed: Apr. 13, 2004

(30) Foreign Application Priority Data
Dec. 20, 2003 (KR) 2003-94311

(51) Int. Cl. B29D 11/00

(52) U.S. Cl. 216/26

(57) ABSTRACT

The present invention relates to a microlens fabrication method for fabricating a non-global microlens from a multi-layer substrate. In the microlens fabrication method of the invention, a first layer of a predetermined etching rate is formed first, and then a second layer is formed on the first layer. The second layer has a predetermined etching rate different from that of the first layer. A mask pattern in use for etching is formed on the second layer, and then the first and second layers are etched to form a non-spherical lens contour therein.

### BACKGROUND OF THE INVENTION

1. Field of the Invention

The present invention relates to a microlens fabrication method, more particularly, for fabricating a non-global microlens from a multi-layer substrate.

2. Description of the Related Art

Microlenses are widely used in various fields including an optical pickup, an image sensor module, a camera and a scanner. In particular, development of more precise and small-sized microlenses is recently accelerated owing to miniaturization, integration and high performance requirements to optical instruments.

As lens size is reduced up to micrometer scale, it is impossible to fabricate microlenses through precision machining. Although lasers are recently adopted as a result to precisely fabricate microlenses, the laser machining has poor throughput and thus high fabrication cost.

In order to realize precision machining of high productivity, various researches have been made so that the microlens fabrication can adopt the Micro Electro-Mechanical System (hereinafter will be referred to as ‘MEMS’) technology based upon the semiconductor processing. The microlens fabrication using the MEMS technology can realize precision machining and more advantageous aspects in mass production.

A conventional microlens fabrication process using the MEMS technology is illustrated in FIG. 1. The conventional microlens fabrication process using the MEMS technology performs the following steps.

First, as shown in FIG. 1A, a photomask 110 is applied on a substrate 100, in which a lens contour is to be formed. It is necessary for the mask 110 to be covered uniformly on those portions to be etched. Then, isotropic etching is performed to the substrate 100, forming a concave hemispherical contour 120 in the substrate 100 as shown in FIG. 1B.

When the concave contour 120 is formed, the mask 110 is removed from the substrate 100, which then can be used as a concave lens. Further, molding material may be filled into the concave contour 120 by utilizing the substrate 100 as a mold in order to fabricate a convex lens of a radius R.

While the conventional microlens fabrication process using the MEMS technology has been disclosed with reference to FIG. 1, the use of this process is limited to spherical lens fabrication, but inapplicable to non-spherical lens fabrication.

As shown in FIG. 2A, a spherical lens has a hemispherical geometry of a predetermined curvature. The spherical aberration is caused because a spherical lens or mirror does not focus parallel rays to a point, thereby failing to reproduce a perfect image of an object. For lenses made with spherical surfaces, peripheral light rays are brought to a focus closer to the lens than are central ones as in FIG. 2A.

Because of the spherical aberration, an image is not focused to the same point, and thus looks blurred or distorted. Accordingly, non-spherical lenses are used in order to reduce the spherical aberration.

An illustrative non-spherical lens is shown in FIG. 2B. Compared to spherical lenses of a fixed radius of curvature, non-spherical lenses have a larger radius of curvature in the periphery than in the center, thereby to reduce the blurriness of an image observed in spherical lenses. For example, a watch or clock covered with a non-spherical lens shows the original shape even if seen in any directions. In order to remove the spherical aberration from spherical lenses, the radius of a lens is adjusted into the best form or several lenses are combined in use. On the contrary, a single non-spherical lens shows the performance of focusing parallel light rays to a point very precisely which is similar to or same as that obtained by several spherical lenses so that optical elements can be reduced in size and mass.

However, conventional microlens fabrication processes based upon the MEMS technology do not provide non-spherical lenses. Furthermore, it is extremely difficult to fabricate microscale non-spherical lenses.

### SUMMARY OF THE INVENTION

Therefore the present invention has been made to solve the foregoing problems of the prior art.

It is an object of the present invention to provide a microscale non-spherical lens fabrication method capable of freely controlling the curvature of a lens while reducing the thickness thereof.

According to an aspect of the invention for realizing the object, there is provided a microlens fabrication method comprising the following steps of:
(a) forming a first layer of a predetermined etching rate;
(b) forming a second layer on the first layer, the second layer having a predetermined etching rate different from that of the first layer;
(c) forming a mask pattern in use for etching on the second layer; and
(d) etching the first and second layers to form a non-spherical lens contour therein.

It is preferred that the etching step (d) comprises isotropic etching, wherein the etching rate of the first layer is lower than that of the second layer, and wherein the second layer is etched more rapidly than the first layer.

The microlens fabrication method may further comprise the step of (e) heat-treating the first layer to lower the etching rate of the first layer after the first layer-forming step (a), wherein each of the first and second layers is preferably made of a material selected from a group including polymer, silica, silicon and metal.

It is preferred that the first and second layers are doped so that the doping concentration of the first layer is larger than that of the second layer, and the first and second layers are made of silica.

It is also preferred that the second layer is deposited on an upper face of the first layer. In addition, the microlens fabrication method may further comprise the step of (f) filling molding material into the lens contour in the first and second layers by using the lens contour as a mold so as to form a microlens.

According to another aspect of the invention for realizing the object, there is provided a microlens fabrication method comprising the following steps of:
(a) forming at least two layers having their own etching rates different from one another;
(b) forming an etching mask pattern on the at least two layers; and
(c) etching the at least two layers to form a non-spherical lens contour therein.

It is preferred that the etching step (c) comprises isotropic etching, wherein an upper one of the layers has a higher etching rate than a lower one, and wherein an upper one of the layers has a higher horizontal etching rate than a lower one.

The microlens fabrication method may further comprise the step of (d) heat treating a layer structure following the formation of each one of the layers to lower the etching rate of each existing layer, wherein each of the layers is preferably made of a material selected from a group including polymer, silica, silicon and metal.

It is preferred that a lower one of the layers has a higher doping concentration than a higher one overlying the lower layer, and the layers are made of silica.

It is preferred that a higher one of the layers is deposited on a top surface of a lower one. In addition, the microlens fabrication method may further comprise the step of (e) filling molding material into the lens contour in the layers by using the lens contour as a mold so as to form a microlens.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A to 1D are stepwise sectional views illustrating a conventional microlens fabrication process using the MEMS technology;

FIG. 2A illustrates a spherical lens;

FIG. 2B illustrates a non-spherical lens;

FIGS. 3A to 3C are stepwise sectional views illustrating a microlens fabrication process according to a preferred embodiment of the invention;

FIGS. 4A and 4B are stepwise sectional views illustrating a microlens fabrication process according to an alternative embodiment of the invention; and

FIG. 5 compares the geometry of a lens produced according to a microlens fabrication method of the invention with that of a conventional spherical lens.

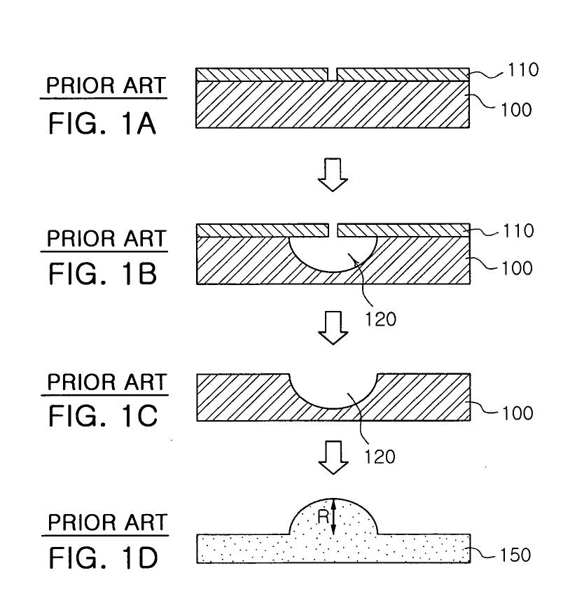

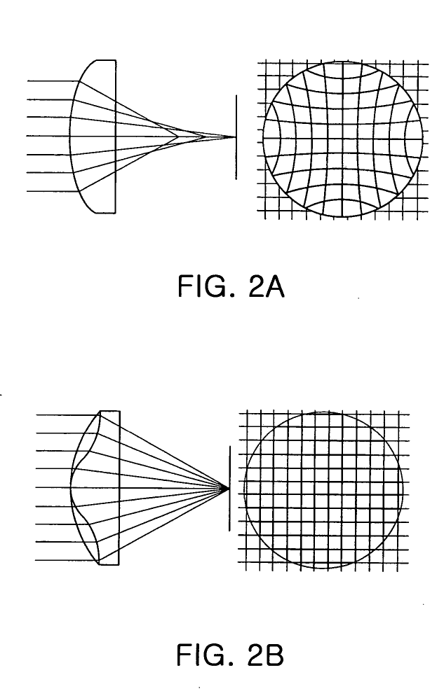

### DETAILED DESCRIPTION OF THE PREFERRED EMBODIMENT

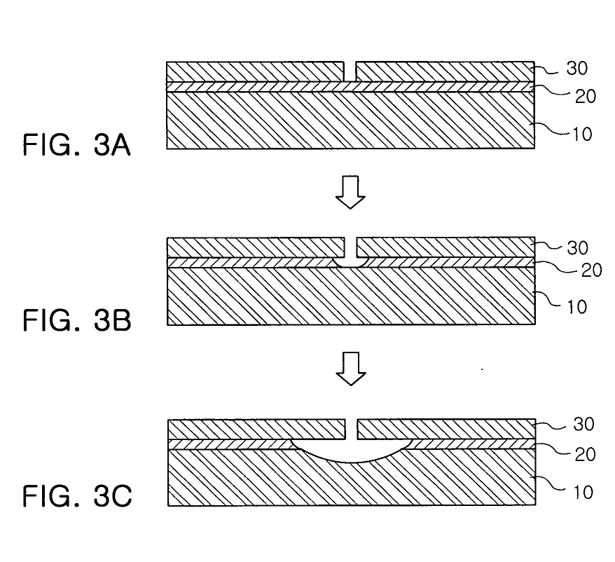

A preferred embodiment of the present invention will now be described in detail with reference to FIGS. 3A to 3C illustrating a microlens fabrication process of the invention. The microlens fabrication process of the invention has a technical feature of etching at least two substrate layers into a lens contour.

Hereinafter reference will be made to FIGS. 3A to 3C to describe the microlens fabrication method for fabricating a microlens from first and second substrate layers.

First, as shown in FIG. 3A, a first substrate layer 10 of a predetermined etching rate is formed. The first substrate layer 10 is made of one material selected from the group consisting of polymer, silica and silicon. Alternatively, the first layer 10 may be made of metal in case that it will function as a mold in future molding.

A second substrate layer 20 is formed on the first substrate layer 10. The second substrate layer 20 is also made of one material selected from the group consisting of polymer, silica and silicon. The second substrate layer 20 has an etching rate different from that of the first substrate layer 10.

The second substrate layer 20 is formed on the first substrate layer 10 via for example vapor deposition. In the invention, the first and second substrate layers are etched at their own etching rates different from each other so that the curvature of a lens surface can be formed in a freely controlled fashion. Preferably, the etching rate of the first substrate layer can be made lower than that of the second substrate layer 20.

After the second substrate layer 20 is formed, a mask pattern 30 to be used in etching is formed on the second substrate layer 20.

FIGS. 3A to 3C illustrate a microlens fabrication process where the first substrate layer 10 has an etching rate lower than that of the second substrate layer 20. FIG. 3B shows that the second substrate layer 20 is vertically etched, in which the etched region still has a spherical lens contour resulting from isotropic etching.

However, as the first substrate layer 10 is etched, the etched region shows a non-spherical lens contour. That is, when the second substrate layer 20 is etched to the extent of exposing the first substrate layer 10, vertical etching speeds up compared to the horizontal etching because the etching rate of the first substrate layer 10 is lower than that of the second substrate layer, so that a non-spherical lens as shown in FIG. 5 can be fabricated as a result.

The first and second substrate layers can be provided with different etching rates via heat treatment and doping concentration adjustment as follows.

First, based upon the phenomenon that heat treatment lowers the etching rate of a substrate layer, each substrate layer is heat-treated prior to the formation of a subsequent substrate layer during the microlens fabrication process in order to form the first and second substrate layers of different etching rates.

In order to regulate the etching rate of the first substrate layer to be lower than that of the second substrate layer, it is preferred to heat treat the first substrate layer 10 after the formation thereof to lower the etching rate thereof. Then, the second substrate layer 20 is formed on the first substrate layer 10. This policy can provide the first and second substrate layers 10 and 20 with different etching rates.

The heat treatment is performed at a temperature generally higher than the deposition temperature in a nitrogen or oxygen atmosphere, and alternatively, in the vacuum or the air. A typical PECVD oxide film is deposited at a temperature of 500° C. or less, in which some elements of the oxide film may not be physically or chemically stable so that the oxide film is easily affected from chemical invasion. As a result, the heat treatment is performed at a temperature range of about 500 to 1000° C. to further enhance the physical or chemical stability of the oxide film thereby lowering the etching rate. For example, the heat treatment may be performed with a furnace or via the Rapid Thermal Annealing (RTA).

The heat treatment can raise the etching rate difference up to 10 times.

Instead of the heat treatment for imparting different etching rates to the first and second layers, the etching rates can be varied by adjusting doping concentrations of impurities or dopants in the substrate layers. The doping is generally performed in the semiconductor art to obtain desired properties based upon impurities or dopants.

The doping concentration can be adjusted in a substrate made of transparent material such as silica compound. Undoped silica compound exists in a stable state, but doped silica compound contains various faults in silica bonding, which reduce the bonding force so that etching can be carried out more easily. In general, the etching rate is raised in proportion to the doping concentration.

In order to adjust the doping concentration, a gas of desired dopant may be flown for the purpose of in situ deposition on a substrate layer. Alternatively, dopants pre-deposited on a substrate may be diffused into a film.

The first and second substrate layers of different etching rates are isotropically etched into a laterally symmetric configuration. The isotropic etching is generally performed in the form of wet etching, but may be in the form of dry etching also.

As the lens contour is formed in the first and second substrate layers as above, the resultant substrate structure can be directly used as a concave lens. Alternatively, molding material may be filled into the lens contour of the substrate layers by using the substrate structure as a mold.

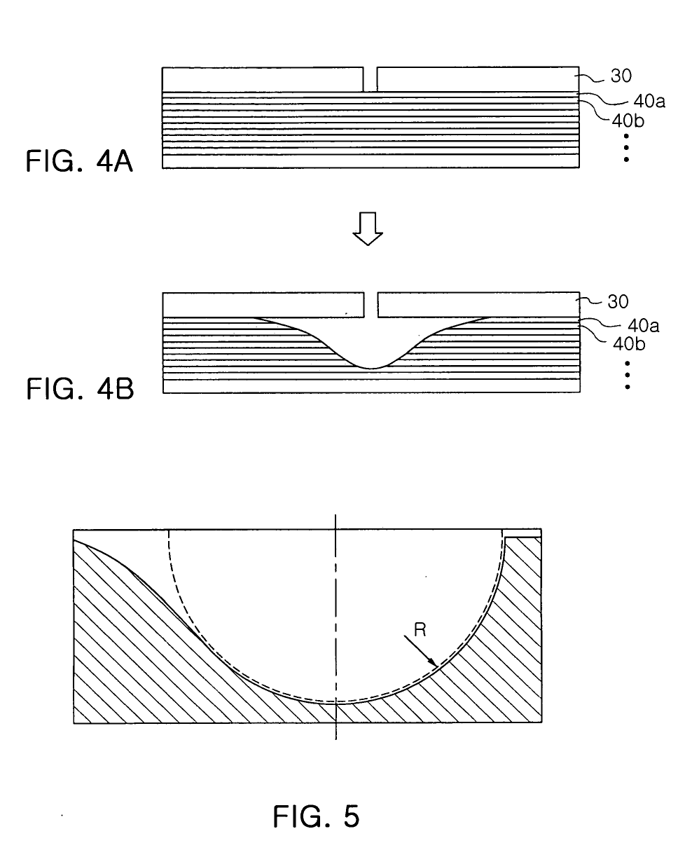

In the foregoing embodiment as shown in FIGS. 3A to 3C, it has been described that non-spherical lenses are fabricated through the formation of the first and second substrate layers and the subsequent etching thereof. The present invention may fabricate more precise non-spherical lenses by etching a multilayer substrate structure as shown in FIGS. 4A and 4B which are stepwise sectional views illustrating a fabrication process according to a second embodiment of the invention.

In the embodiment in FIGS. 4A and 4B, the substrate layers are formed into multiple layers 40a, 40b, . . . and 40n having etching rates different from one another. As shown in FIG. 4A, a substrate structure of the multiple layers of etching rates different from one another is prepared. A mask pattern 30 for etching is formed on the uppermost substrate layer 40a.

Then, the multilayer substrate structure is etched to form a non-spherical lens contour. The non-spherical lens contour obtained as above can be utilized as a concave lens. Alternatively, molding material may be filled into the non-spherical lens contour to fabricate a convex lens by using the substrate structure having the non-spherical lens contour as a mold. As a result, the substrate structure can be made of a transparent material selected from the group consisting of silica, silicon and polymer or metal.

As in the first embodiment shown in FIGS. 3A and 3B, this embodiment can heat treat the respective substrate layers subsequent to the formation thereof to lower their etching rates so that the etching rates of the respective substrate layers can be made different from one another. That is, according to this embodiment shown in FIGS. 4A and 4B, following the heat treatment of the lowermost one of the layers, a second one layer is formed on the heat-treated lowermost layer, and then the whole substrate structure is heat treated. This process is repeated to the uppermost one of the layers so that the lowermost layer is heat treated more than other layers. As a result, a higher substrate layer has a higher etching rate than a lower substrate layer.

This substrate structure can be realized by varying doping concentrations of the respective substrate layers. Different doping concentrations can be obtained by varying the flow rate of source gas to be doped during deposition. Alternatively, dopants pre-deposited on an oxide film may be diffused into the film to create the doping concentration gradient.

For example silica may be deposited in situ to form the doping concentration gradient in a vertical direction to potentially fabricate lenses of a smoother configuration. That is, source gas may be deposited in situ by gradually varying the flow rate so that the doping concentration can be varied continuously according to the deposition sequence of films in the substrate structure.

FIG. 5 compares the geometry of a lens produced according to a microlens fabrication method of the invention with that of a conventional spherical lens.

In FIG. 5, a dotted lens shape indicates a conventional spherical lens of a radius R. The spherical lens is fabricated according to the conventional fabrication method based upon the MEMS technology.

The present invention discloses the fabrication method capable of fabricating non-spherical lenses based upon the MEMS technology, and a solid lens shape in FIG. 5 indicates a non-spherical lens fabricated thereby. It can be understood that the lens fabricated according to the method of the invention has a non-spherical shape compared with the spherical lens in a solid line.

As set forth above, the present invention provides a method for fabricating microscale non-spherical lenses in microlens fabrication, by which a multilayer substrate structure in use for lens fabrication can be formed to freely control the curvature of lenses at a smaller thickness.

The present-invention also proposes a method of forming a substrate structure of multiple layers having different etching rates in order to more precisely control the shape of non-spherical lenses.

While the present invention has been shown and described in connection with the preferred embodiments, it will be apparent to those skilled in the art that modifications and variations can be made without departing from the spirit and scope of the invention as defined by the appended claims.

1. A microlens fabrication method comprising the following steps of:
(a) forming a first layer of a predetermined etching rate;
(b) forming a second layer on the first layer, the second layer having a predetermined etching rate different from that of the first layer;
(c) forming a mask pattern in use for etching on the second layer; and
(d) etching the first and second layers to form a non-spherical lens contour therein.

2. The microlens fabrication method according to claim 1, wherein the etching step (d) comprises isotropic etching.

3. The microlens fabrication method according to claim 1, wherein the etching rate of the first layer is lower than that of the second layer.

4. The microlens fabrication method according to claim 3, wherein the second layer is etched more rapidly than the first layer.

5. The microlens fabrication method according to claim 4, further comprising the step of (e) heat-treating the first layer to lower the etching rate of the first layer after the first layer-forming step (a).

6. The microlens fabrication method according to claim 5, wherein each of the first and second layers is made of a material selected from a group including polymer, silica, silicon and metal.

7. The microlens fabrication method according to claim 4, wherein the first and second layers are doped so that the doping concentration of the first layer is larger than that of the second layer.

8. The microlens fabrication method according to claim 7, wherein the first and second layers are made of silica.

9. The microlens fabrication method according to claim 1, wherein the second layer is deposited on an upper face of the first layer.

10. The microlens fabrication method according to claim 1, further comprising the step of (f) filling molding material into the lens contour in the first and second layers by using the lens contour as a mold so as to form a microlens.

11. A microlens fabrication method, comprising the following steps of:
(a) forming at least two layers having their own etching rates different from one another;
(b) forming an etching mask pattern on the at least two layers; and
(c) etching the at least two layers to form a non-spherical lens contour therein.

12. The microlens fabrication method according to claim 11, wherein the etching step (c) comprises isotropic etching.

13. The microlens fabrication method according to claim 11, wherein an upper one of the layers has a higher etching rate than a lower one.

14. The microlens fabrication method according to claim 13, wherein an upper one of the layers has a higher horizontal etching rate than a lower one.

15. The microlens fabrication method according to claim 14, further comprising the step of (d) heat treating a layer structure following the formation of each one of the layers to lower the etching rate of each existing layer.

16. The microlens fabrication method according to claim 15, wherein each of the layers is made of a material selected from a group including polymer, silica, silicon and metal.

17. The microlens fabrication method according to claim 14, wherein a lower one of the layers has a higher doping concentration than a higher one overlying the lower layer.

18. The microlens fabrication method according to claim 17, wherein the layers are made of silica.

19. The microlens fabrication method according to claim 11, wherein a higher one of the layers is deposited on a top surface of a lower one.

20. The microlens fabrication method according to claim 11, further comprising the step of (e) filling molding material into the lens contour in the layers by using the lens contour as a mold so as to form a microlens.
